(19) United States
(12) Patent Application Publication
(10) Pub. No.: US 2026/0072576 A1
(43) Pub. Date: Mar. 12, 2026

(54) MEDIA CONTENT PROCESSING METHOD, APPARATUS, DEVICE, READABLE STORAGE MEDIUM AND PRODUCT

(71) Applicant: Beijing Zitiao Network Technology Co., Ltd., Beijing (CN)

(72) Inventors: Yiying Wu, Beijing (CN); Xiaoshuang Bai, Beijing (CN); Nuomeng Zhang, Beijing (CN); Yiran Liu, Beijing (CN)

(21) Appl. No.: 19/107,789

(22) PCT Filed: Aug. 30, 2023
(86) PCT No.: PCT/CN2023/115760

§ 371 Date: Feb. 28, 2025

(30) Foreign Application Priority Data
Aug. 30, 2022 (CN) 202211049252.4

(51) Int. Cl. G06F 3/0484; G06F 3/0481; G06F 40/166; G06V 10/70; G06V 10/94; G06V 20/70

(52) U.S. Cl. CPC G06F 3/0484; G06F 3/0481; G06V 10/70; G06V 10/945; G06V 20/70; G06F 40/166

(57) ABSTRACT

Embodiments of the disclosure provide a media content processing method, apparatus, electronic device, computer readable storage medium, computer program product and computer program. The method includes: obtaining a media content to be recognized in response to an obtaining operation in a content recognition page; recognizing the media content to be recognized to determine recognition information corresponding to the media content to be recognized; displaying at least one recognition result corresponding to the recognition information, wherein the recognition result includes identification information and/or association information of a predetermined object in the media content to be recognized; and generating, in response to a posting operation triggered by a first user, a target media content obtained based on the obtaining operation, wherein the target media content includes the at least one recognition result.

### CROSS-REFERENCING TO RELATED APPLICATIONS

The present disclosure is the U.S. National Stage of International Application No. PCT/CN 2023/115760, filed on Aug. 30, 2023, which claims priority to Chinese Patent Application No. 202211049252.4, entitled “Media Content Processing Method, Apparatus, Device, Readable Storage Medium, and Product” and filed Aug. 30, 2022, the disclosures of which are incorporated herein by reference in their entities.

### FIELD

Embodiments of the present disclosure relate to the technical field of data processing, and in particular, to a media content processing method, apparatus, electronic device, computer readable storage medium, computer program product and computer program.

### BACKGROUND

At present, a variety of applications provide users with the function of image code scanning. The user may add friends, participate in activities, recognize content and the like through the image code scanning function.

### SUMMARY

The embodiments of the present disclosure relate to the technical field of data processing, and in particular, to a media content processing method, apparatus, electronic device, computer readable storage medium, computer program product and computer program.

In a first aspect, an embodiment of the present disclosure provides a media content processing method, comprising:
obtaining a media content to be recognized in response to an obtaining operation in a content recognition page;
recognizing the media content to be recognized to determine recognition information corresponding to the media content to be recognized;
displaying at least one recognition result corresponding to the recognition information, wherein the recognition result comprises identification information and/or association information of a predetermined object in the media content to be recognized; and
generating, in response to a posting operation triggered by a first user, a target media content obtained based on the obtaining operation, wherein the target media content comprises the at least one recognition result.

In a second aspect, an embodiment of the present disclosure provides a media content processing method, comprising:
playing a target media content in a media content playing page, wherein the target media content comprises object information of at least one predetermined object, and the object information comprises identification information and/or association information; and
in response to a triggering operation of a second user on first object information in the at least one object information, switching to a content displaying page, and displaying, in the content displaying page, a resource content associated with the object information.

In a third aspect, an embodiment of the present disclosure provides a media content processing apparatus, comprising:
an obtaining module configured to obtain a media content to be recognized in response to an obtaining operation in a content recognition page;
a recognizing module configured to recognize the media content to be recognized to determine recognition information corresponding to the media content to be recognized;
a displaying module configured to display at least one recognition result corresponding to the recognition information, wherein the recognition result comprises identification information and/or association information of a predetermined object in the media content to be recognized; and
a generating module configured to generate, in response to a posting operation triggered by a first user, a target media content obtained based on the obtaining operation, wherein the target media content comprises the at least one recognition result.

In a fourth aspect, an embodiment of the present disclosure provides a media content processing apparatus, comprising:
a playing module configured to play a target media content in a media content playing page, wherein the target media content comprises object information of at least one predetermined object, and the object information comprises identification information and/or association information; and
a processing module configured to, in response to a triggering operation of a second user on first object information in the at least one object information, switch to a content displaying page, and display, in the content displaying page, a resource content associated with the object information.

In a fifth aspect, an embodiment of the present disclosure provides an electronic device, comprising a processor and a memory, wherein
the memory stores computer executable instructions;
the at least one processor executes the computer-executable instructions stored in the memory, so that the at least one processor executes the media content processing method according to the first aspect and various possible designs of the first aspect.

In a sixth aspect, an embodiment of the present disclosure provides a computer-readable storage medium, wherein the computer-readable storage medium stores computer-executable instructions which, when executed by a processor, implement the media content processing method according to the first aspect and various possible designs of the first aspect.

In a seventh aspect, an embodiment of the present disclosure provides a computer program product, comprising a computer program, wherein the computer program, when executed by a processor, implements the media content processing method according to the first aspect and various possible designs of the first aspect.

In an eighth aspect, an embodiment of the present disclosure provides a computer program, wherein the computer program, when executed by a processor, implements the media content processing method according to the first aspect and various possible designs of the first aspect.

According to the media content processing method, apparatus, electronic equipment, computer readable storage medium, computer program product and computer program, a media content to be recognized is recognized, recognition information corresponding to the media content to be recognized is determined, so that at least one recognition result corresponding to the recognition information can be displayed, and a target media content can be generated according to the media content to be recognized and the at least one recognition result based on a posting operation triggered by the user.

### BRIEF DESCRIPTION OF THE DRAWINGS

In order to more clearly illustrate the technical solutions in the embodiments of the present disclosure or related technologies, the accompanying drawings used in the description of the embodiments or related technologies are briefly introduced below, and it is obvious that the drawings in the following description are some embodiments of the present disclosure.

FIG. 1 is a schematic flowchart of a media content processing method according to an embodiment of the present disclosure;

FIG. 2 is an interface interaction diagram of content recognition according to an embodiment of the present disclosure;

FIG. 3 is a schematic flowchart of a media content processing method according to another embodiment of the present disclosure;

FIG. 4 is a schematic diagram of another interface interaction according to an embodiment of the present disclosure;

FIG. 5A is a schematic diagram of still another interface interaction according to an embodiment of the present disclosure;

FIG. 5B is a schematic diagram of still another interface interaction according to an embodiment of the present disclosure;

FIG. 6 is a schematic diagram of a displaying interface according to an embodiment of the present disclosure;

FIG. 7 is a schematic flowchart of a media content processing method according to an embodiment of the present disclosure;

FIG. 8 is a schematic diagram of interface interaction according to an embodiment of the present disclosure;

FIG. 9 is a schematic structural diagram of a media content processing apparatus according to an embodiment of the present disclosure;

FIG. 10 is a schematic structural diagram of a media content processing apparatus according to another embodiment of the present disclosure; and

FIG. 11 is a schematic structural diagram of an electronic device according to an embodiment of the present disclosure.

### DETAILED DESCRIPTION

In order to make the objectives, technical solutions and advantages of the embodiments of the present disclosure more apparent, the technical solutions in the embodiments of the present disclosure will be clearly and completely described below with reference to the accompanying drawings in the embodiments of the present disclosure. It is obvious that the embodiments to be described are merely part not all of the embodiments of the present disclosure. All other embodiments obtained by those skilled in the art based on the embodiments of the present disclosure without creative efforts shall fall within the scope of the present disclosure.

In order to solve the technical problem that the application scenario of the existing content recognition function is relatively monotonous and can not meet the actual needs of users, the present disclosure provides a media content processing method, apparatus, electronic device, computer-readable storage medium, computer program product, and computer program.

It should be noted that the media content processing method, apparatus, electronic device, computer-readable storage medium, computer program product, and computer program provided in the present disclosure may be applied to any application scenario in which content recognition needs to be performed.

The existing content recognition function generally recognizes a content to be recognized in response to a content recognition instruction triggered by a user, and displays a recognition result corresponding to the content to be recognized. Usually, functions and application scenarios are relatively monotonous. For example, when the existing image code scanning function performs content recognition, the application scenario is relatively monotonous, which affects the user experience.

In order to enrich the application of the content recognition function, the inventos have found in the research process that a media content to be recognized may be recognized, and a recognition display corresponding to the media content to be recognized may be determined. At least one recognition result corresponding to the recognition information is displayed, and after obtaining a release operation triggered by a user, a target media content obtained based on the media content to be recognized and the at least one recognition result corresponding to the recognition information is generated. On the basis that the identification information corresponding to the media content to be recognized is obtained, the target media content can be generated based on the media content to be recognized and the recognition information, thereby enriching the application scenarios of the recognition function and improving the user experience.

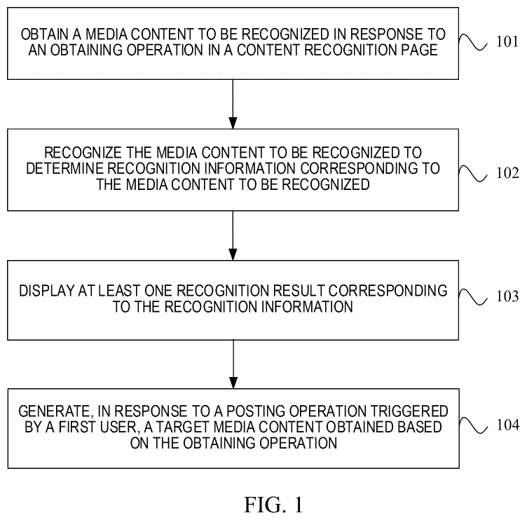

FIG. 1 is a schematic flowchart of a media content processing method according to an embodiment of the present disclosure. As shown in FIG. 1, the method comprises:
Step 101: obtaining a media content to be recognized in response to an obtaining operation in a content recognition page.

The execution body of this embodiment is a media content processing apparatus, which may be coupled to a terminal device. Therefore, the media content to be recognized can be recognized in response to a triggering operation of a first user on the terminal device, and the target media content obtained based on the obtaining operation is generated. Optionally, the media content processing apparatus may be coupled to a server. The server can be communicatively connected to the terminal device, and thus can obtain an instruction sent by the terminal device in response to the triggering operation of the first user, recognize the media content to be recognized, and generate the target media content obtained based on the obtaining operation.

In this embodiment, during using the application software, the first user may perform a triggering operation on a predetermined content recognition control according to actual needs, and enter the content recognition page. For example, the content recognition control may be a predetermined scanning control in the application software, and the scanning control may be triggered to recognize contents such as two-dimensional codes, images, music, videos, and the like.

In the content recognition page, the first user may trigger the obtaining operation to obtain the media content to be recognized. Optionally, the user may obtain the media content to be recognized through a capturing operation or an uploading operation. For example, the first user may trigger a capturing operation according to actual needs to obtain the captured media content to be recognized. Alternatively, the first user may also trigger an uploading operation to obtain the media content to be recognized from a plurality of pre-stored media contents.

The media content to be recognized includes any one of in mage media content, a music media content, a video media content, and a text media content.
Step 102: recognizing the media content to be recognized, and determining recognition information corresponding to the media content to be recognized.

In this embodiment, after the media content to be recognized is obtained, the media content to be recognized may be recognized. The recognition operation of the media content to be recognized may be implemented by using any content recognition algorithm, which is not limited in the present disclosure.

For example, for different media content to be recognized, a matching recognition model may be pre-trained for recognition. When the media content to be recognized is an image media content, a predetermined image recognition model may be used for recognition. When the media content to be recognized is a music media content, a predetermined audio recognition model may be used for recognition. When the media content to be recognized is a video media content, a frame extraction operation may be performed on the video media content in advance, and for each image frame, a predetermined image recognition model is used for recognition. When the media content to be recognized is a text media content, a predetermined text recognition model may be used for recognition.

Further, after the media content to be recognized is recognized, recognition information corresponding to the media content to be recognized may be determined.
Step 103: displaying at least one recognition result corresponding to the recognition information, wherein the recognition result comprises identification information and/or association information of a predetermined object in the media content to be recognized.

In this implementation, after the recognition information corresponding to the media content to be recognized is determined, in order to enable the first user to learn more intuitively the media content to be recognized, at least one recognition result corresponding to the recognition information may be displayed. The recognition result includes identification information and/or association information of a predetermined object in the media content to be recognized. The identification information may be label information corresponding to the predetermined object. The association information may be any information associated with the predetermined object, for example, a triggerable control associated with the predetermined object.

For example, the media content to be recognized may be an image media content, and after the media content to be recognized is recognized, it may be determined that the media content to be recognized includes a predetermined object bouquet, fruit, book, and the like. Therefore, identification information may be displayed in a predetermined range around the bouquet, the fruit and the book, so as to enable the first user to learn about the predetermined object.

Optionally, the identification information may comprise category information to which the predetermined object belongs. For example, for a predetermined object bouquet, the text of the flower may be displayed in the identification information.

Alternatively, the identification information may also comprise specific information of the predetermined object. For example, for a predetermined object bouquet, the text of the tulip may be displayed in the identification information. The first user may set the display content in the identification information according to actual needs, which is not limited in the present disclosure.
Step 104: generating, in response to a posting operation triggered by the first user, a target media content obtained based on the obtaining operation, wherein the target media content comprises the at least one recognition result.

In this implementation, in response to a posting operation triggered by the first user, a target media content obtained based on the obtaining operation may be generated, wherein the target media content comprises the at least one recognition result. Thereby, the target media content can be generated based on the recognition result. Therefore, in the solution of this embodiment, recognition can be realized in the capturing process, works can be generated from the recognition process with a single click, instead of capturing works after recognizing the result. Thus, the linkage between the recognition function and the content posting function is realized, the application scenarios of the recognition function are enriched, and further the user experience can be improved.

Optionally, based on any of the foregoing embodiments, step 101 comprises:
in response to a capturing operation triggered by the first user in the content recognition page, capturing the media content to be recognized through a predetermined content capturing component. Or in response to an uploading operation triggered by the first user in the content recognition page, uploading the media content to be recognized through a predetermined content uploading component.

In this implementations, for different operations triggered by the first user, different components may be used to obtain the media content to be recognized.

Optionally, the media content to be recognized may be captured through a predetermined content capturing component in response to a capturing operation triggered by the first user in the content recognition page. The content recognition page may be predetermined with a capturing control, and in response to a triggering operation of the first user on the capturing control, the media content to be recognized is captured through a predetermined content capturing component.

Optionally, the media content to be recognized is uploaded through a predetermined content uploading component in response to an uploading operation triggered by the first user in the content recognition page. The content recognition page may be predetermined with an uploading control, and in response to a triggering operation performed by the first user on the uploading control, the media content to be recognized is uploaded through a predetermined content uploading component.

Further, based on any of the above embodiments, step 104 comprises:
adding the identification information and/or the association information of the predetermined object at a position matching each predetermined object in the media content to be recognized to obtain the target media content.

In this embodiment, in response to the posting operation triggered by the first user, for each predetermined object in the media content to be recognized, the identification information and/or the association information of the predetermined object may be added at a position matching the predetermined object to obtain the target media content.

Optionally, in order not to block the predetermined object, the identification information and/or the association information may be added within a predetermined area around the predetermined object, e.g., an upper side or a lower side of the predetermined object.

Further, based on any of the above embodiments, after step 104, the method further comprises:
posting the target media content.

In this embodiment, after the target media content is generated, the target media content may be directly posted.

According to the media content processing method provided in this embodiment, the recognition information corresponding to the media content to be recognized is determined by recognizing the media content to be recognized, so that at least one recognition result corresponding to the recognition information can be displayed, and the target media content can be generated based on the media content to be recognized and the at least one recognition result according to the posting operation triggered by the first user. The application scenarios of the content recognition function are enriched, so that the first user can post the target media content based on the recognition result of the content recognition function, the content recognition function better fits actual needs of the first user, and the user experience is improved.

Further, based on any of the above embodiments, after step 102, the method further comprises:
switching to a recognition result page, displaying a predetermined posting control in the recognition result page, and an image content associated with the target media content and/or a resource content associated with the at least one recognition result.

In this embodiment, after the media content to be recognized is recognized and the recognition information corresponding to the media content to be recognized is determined, the recognition result page may be switched to, and the predetermined posting control is displayed in the recognition result page, so that the first user can generate the target media content based on the posting control. In addition, the recognition result page may further display an image content associated with the target media content and/or a resource content associated with the at least one recognition result.

The resource content may comprise one or more of an encyclopedia content corresponding to the recognition result, a graphic content corresponding to the recognition result, a media content corresponding to the recognition result, and a commodity content corresponding to the recognition result, which is not limited in the present disclosure.

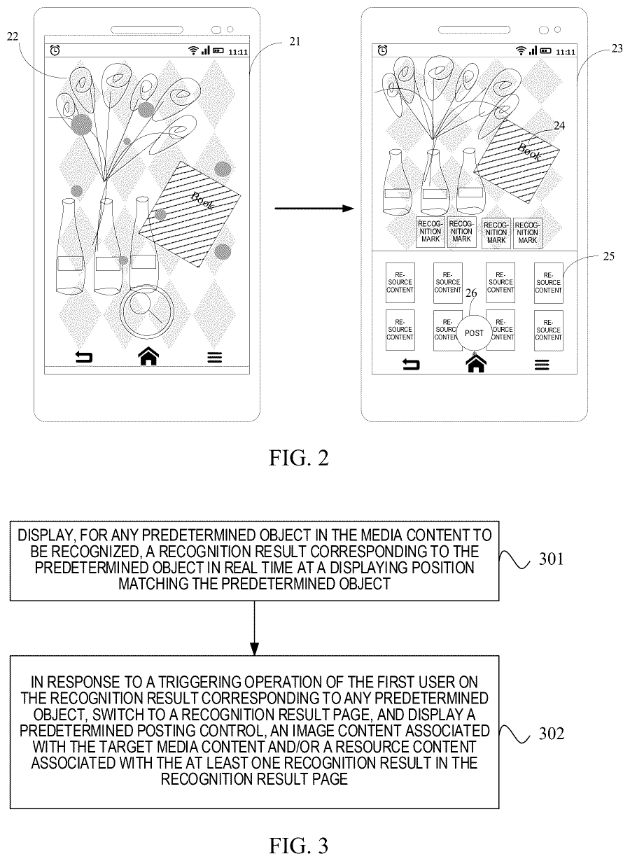

FIG. 2 is a schematic diagram of interface interaction of content recognition according to an embodiment of the present disclosure. As depicted, a media content 22 to be recognized may be recognized in a content recognition page 21 to obtain recognition information. Then, a recognition result page 23 is switched to, wherein the result recognizing page 23 may comprise an image content 24 associated with the target media content, a resource content 25 associated with the at least one recognition result, and a predetermined posting control 26. The posting control 26 is configured to post the recognition process as a work. For example, after the first user clicks the posting control 26, the first user may generate the recognition process as a video for posting. In some embodiments, the complete recognition process may be used as a work to be posted, that is, all images captured after the user performs the obtaining operation are generated as works for posting. In other implementations, at least one frame in all images after obtaining the recognition result may be generated as a work for posting.

Further, based on any of the above embodiments, switching to the recognition result page comprises:
switching to the recognition result page in response to determining the recognition information corresponding to the media content to be recognized.

Optionally, when determining the recognition information corresponding to the media content to be recognized, the recognition result page may be directly switched to, so as to simplify the switch process of the recognition result page. Thus, the user can quickly view the recognition result page.

According to the media content processing method provided in this embodiment, the display content in the recognition result page can be enriched by switching to the recognition result page in response to determining the recognition information corresponding to the media content to be recognized, and displaying the image content associated with the target media content and/or the resource content associated with the at least one recognition result in the recognition result page, so that the first user can view more information associated with the target media content in the recognition result page. In addition, the application scenarios of the recognition function can be enriched.

FIG. 3 is a schematic flowchart of a media content processing method according to still another embodiment of the present disclosure.
Step 301: for any predetermined object in the media content to be recognized, displaying a recognition result corresponding to the predetermined object in real time at a display position matching the predetermined object.
Step 302: in response to a triggering operation of the first user on the recognition result corresponding to any predetermined object, switching the recognition result page, and displaying a predetermined posting control and an image content associated with the target media content and/or a resource content associated with the at least one recognition result in the recognition result page.

In this embodiment, in order to enable the first user to view the recognition result more intuitively, after recognizing the media content to be recognized and determining the recognition information corresponding to the media content to be recognized, for any predetermined object in the media content to be recognized, the recognition result corresponding to the predetermined object may be displayed in real time in a display position matching the predetermined object. For example, when the media content to be recognized is an image media content, for each predetermined object in the image media content, a recognition result corresponding to the predetermined object may be displayed in real time around the predetermined object immediately after the predetermined object is recognized, the recognition result may be label information corresponding to the predetermined object, and a name of the predetermined object is displayed on the identification label. It may be understood that when the user subsequently performs a posting operation, the recognition process may be generated as a video for posting. In some implementations, the complete recognition process may be used as a work to be posted, that is, all images captured after the user performs the obtaining operation are generated as a work for posting, and the label information in the work appears after the recognition information is obtained; in some other implementations, at least one frame in all images obtained after the recognition result is obtained may be generated as a work for posting.

Optionally, the recognition result may be configured as triggerable label information. In response to the triggering operation of the first user on the recognition result corresponding to any predetermined object, the recognition result page may be switched to, and a predetermined posting control is displayed in the recognition result page, so that the first user performs a generating operation for the target media content based on the posting control. In addition, the recognition result page may further display an image content associated with the target media content and/or a resource content associated with the at least one recognition result.

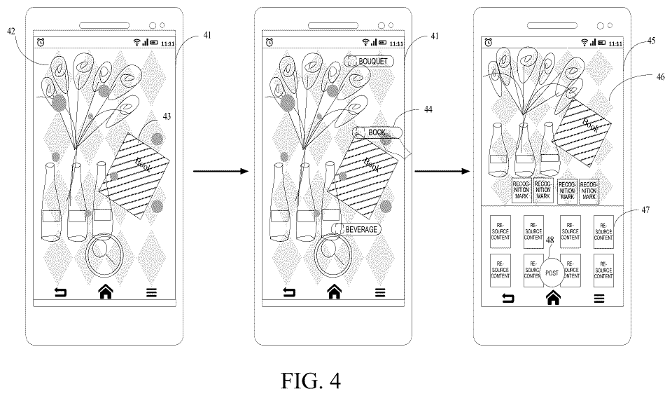

FIG. 4 is another schematic diagram of interface interaction according to an embodiment of the present disclosure. As shown in FIG. 4, a media content to be recognized 42 may be recognized in a content recognition page 41, to obtain recognition information. For any predetermined object 43 in the media content to be recognized 42, a recognition result 44 corresponding to the predetermined object 43 may be displayed at a position matching the predetermined object 43. In response to a triggering operation of the first user on the recognition result 44, a recognition result page 45 is switched to, wherein the result recognition page 45 may comprise an image content 46 associated with the target media content, a resource content 47 associated with at least one recognition result, and a predetermined posting control 48. The posting control 48 is configured to post the recognition process as a work.

According to the media content processing method provided by this embodiment, the recognition result corresponding to the predetermined object is displayed in real time at the display position matching the predetermined object, so that the first user can more intuitively learn about the predetermined object. In addition, in response to the triggering operation of the first user on the recognition result, the recognition result page is switched to, and an image content associated with the target media content and/or a resource content associated with the at least one recognition result are displayed in the recognition result page, so that the display content in the recognition result page can be enriched, and the first user can view more information associated with the target media content in the recognition result page. In addition, the application scenarios with the recognition function can be enriched.

Optionally, based on any of the foregoing embodiments, step 104 comprises:
generating, in response to a triggering operation of the first user on the posting control, a target media content obtained based on the obtaining operation.

In this embodiment, since a posting control is configured in the recognition result page, the first user can realize the generation of the target media content through the triggering operation on the posting control. Optionally, the target media content obtained based on the obtaining operation may be generated in response to a triggering operation of the first user on the posting control.

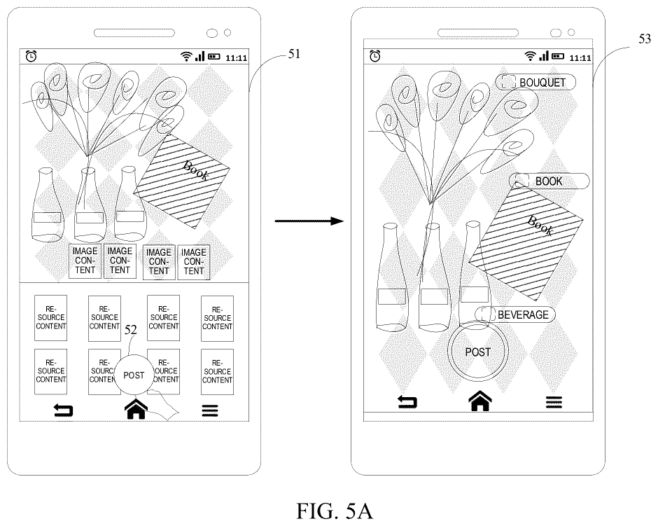

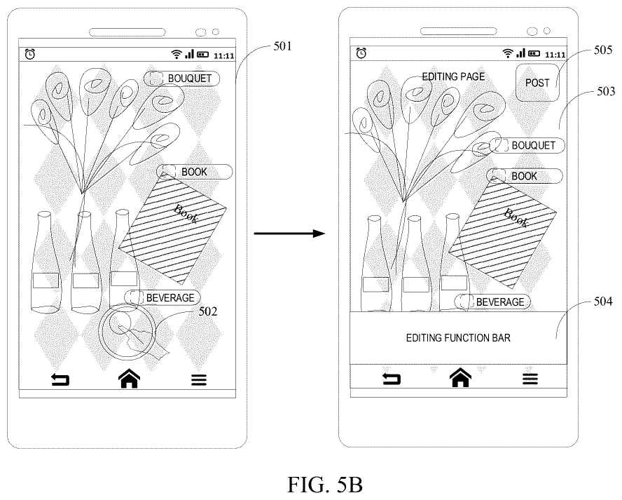

FIG. 5A is another schematic diagram of interface interaction provided by an embodiment of the present disclosure. As shown in FIG. 5A, a posting control 52 is configured in a result recognition page 51, and in response to a triggering operation of the first user on the posting control 52, a target media content 53 for posting may be generated.

Optionally, based on any of the foregoing embodiments, step 104 comprises:
switching to a predetermined editing page in response to a first predetermined operation triggered by the first user;
generating and posting the target media content in response to a second predetermined operation triggered by the first user in the editing page.

In this embodiment, in order to make the finally posted target media content better fit the personalized requirement of the first user, the predetermined editing page is switched to in response to the first predetermined operation triggered by the first user, so that the first user implements editing of the target media content in the editing page. Optionally, a capturing control may be predetermined in the content recognition page, and a triggering operation of the first user on the capturing control may be determined as the first predetermined operation.

After switching to the editing page, the editing page may comprise a predetermined editing function bar, through which the first user may edit the media and generate and post the target media content. Optionally, the editing page may be provided with a complete control, and the target media content may be generated and posted in response to a triggering operation of the first user on the complete control. Alternatively, the editing page may be provided with a posting control, and the target media content may be generated and posted in response to a triggering operation of the first user on the posting control.

FIG. 5B is a schematic diagram of interface interaction according to still another embodiment of the present disclosure. As shown in FIG. 5B, in response to a triggering operation of the first user on a predetermined capturing control 502 in a content recognition page 501, an editing page 503 is switched to. The first user may edit the media content through an editing function bar in the editing page 503, and generate and post the target media content by triggering a predetermined posting icon 505.

According to the media content processing method provided by this embodiment, the target media content is generated in response to the operation of the first user on the predetermined posting control in the recognition result page, so that the first user can conveniently post the target media content based on the media content to be recognized and the recognition information, the application scenario of the recognition function is enriched, the posting process of the target media content is simplified, and the first user experience is improved.

Optionally, based on any of the above embodiments, after step 102, the method further comprises:
displaying a predetermined posting control in the content recognition page.

Step 104 comprises:
generating, in response to a triggering operation of the first user on the posting control, a target media content obtained based on the obtaining operation.

In this embodiment, in order to simplify the generating process of the target media content, the predetermined posting control may be displayed in the content recognition page. After completing the recognition of the media content to be recognized and determining the recognition information corresponding to the media content to be recognized, the first user may perform a triggering operation on the posting control according to actual needs. In response to the triggering operation, the target media content obtained based on the obtaining operation may be generated. Therefore, the generating operation on the target media content can be directly realized in the content recognition page.

According to the media content processing method provided in this embodiment, the posting control is set in the content recognition page, so that the first user can implement the generating operation on the target media content in the content recognition page, thereby simplifying the generating process of the target media content. In addition, in response to an operation of the first user on the predetermined posting control in the recognition result page, the target media content is generated, so that the first user can post the target media content based on the media content to be recognized and the recognition information, and the application scenario of the recognition function is enriched.

Further, based on any of the above embodiments, displaying the predetermined posting control and the image content associated with the target media content and/or the resource content associated with the at least one recognition result in the recognition result page comprises:
displaying the image content associated with the target media content and at least one recognition mark corresponding to the image content associated with the target media content in a first display area in the recognition result page;
displaying the resource content associated with the first recognition mark and the predetermined posting control in a second display area in the recognition result page.

In this embodiment, the recognition result page comprises a first display area and a second display area. The first display region may be laterally arranged, or may also be vertically arranged, and the first user may adjust the display position and the display size of the first display area and the second display area according to actual needs, which is not limited in the present disclosure.

After switching to the recognition result page, the image content associated with the target media content and the at least one recognition mark corresponding to the image content associated with the target media content may be displayed in the first display area in the recognition page. The recognition mark may specifically be a screenshot or a thumbnail corresponding to each predetermined object in the target media content.

In the second display area in the recognition result page, the resource content associated with the first recognition mark may be displayed. The resource content may specifically comprise one or more of an encyclopedia content corresponding to the first recognition mark, a graphic content corresponding to the first recognition mark, a media content corresponding to the first recognition mark, and a commodity content corresponding to the first recognition mark, which is not limited in the present disclosure.

In addition, a predetermined posting control is further displayed in the second display area, so that the first user can realize the generating operation of the target media content in the recognition result page based on the posting control.

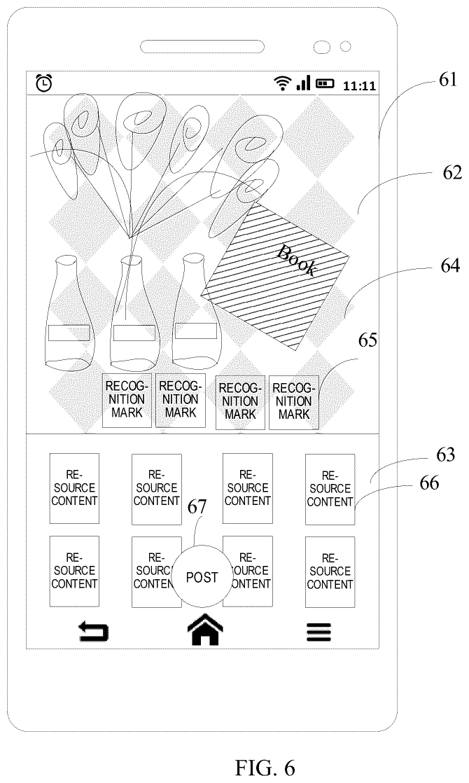

FIG. 6 is a schematic diagram of a display interface according to an embodiment of the present disclosure. As shown in FIG. 6, a recognition result page 61 comprises a first display area 62 and a second display area 63. An image content 64 associated with the target media content, at least one recognition mark 65 corresponding to the image content 64 associated with the target media content are displayed in the first display area 62. A resource content 66 associated with the first recognition mark and a predetermined posting control 67 are displayed in the second display area 63.

According to the media content processing method provided in this embodiment, the image content associated with the target media content and the at least one recognition mark corresponding to the image content associated with the target media content are displayed in the first display area, and the resource content associated with the first recognition mark and the predetermined posting control are displayed in the second display area, so that the display content in the recognition result page can be enriched, and the first user can obtain more information in the recognition result page. In addition, the posting control is displayed in the recognition result page, so that the target media content can be generated according to the triggering operation of the first user on the posting control.

Further, based on any of the above embodiments, after displaying the resource content associated with the first recognition mark and the predetermined posting control in the second display area in the recognition result page, the method further comprises:
in response to a switching operation of the first user in the recognition result page,
switching a resource content associated with a second recognition mark in the second display area.

In this embodiment, after displaying the resource content associated with the first recognition mark in the second display area in the recognition result page, the first user may switch the currently displayed resource content according to actual needs. Optionally, the first user may perform a switching operation in the recognition result page to select a recognition mark. In response to the switching operation, the resource content associated with the second recognition mark may be switched in the second display area. Optionally, the first user may perform the switching operation in the recognition result page in a swiping manner, or may directly trigger a desired recognition mark to realize the switching operation.

For example, if the current second display area displays the resource content of a bouquet, the first user may perform a switching operation on a recognition mark in the first display area, and switch to the book recognition mark. Correspondingly, the resource content corresponding to the book may be displayed in the second display area.

According to the media content processing method provided by the embodiment, the currently displayed resource content is switched in response to the switching operation of the first user in the recognition result page, so that the display content in the recognition result page can be further enriched, and the first user can comprehensively learn about the resource content corresponding to each recognition mark in the recognition result page.

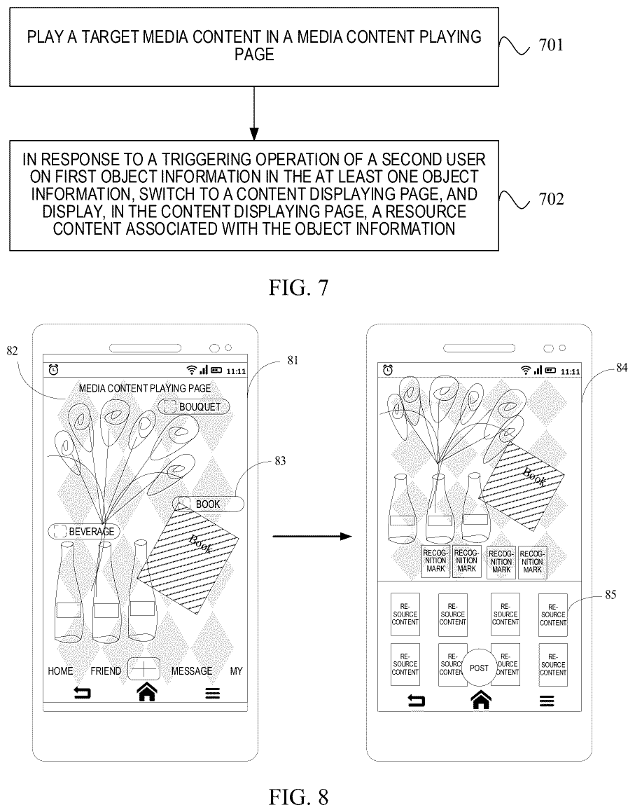

FIG. 7 is a schematic flowchart of a media content processing method according to an embodiment of the present disclosure.
Step 701: playing a target media content in a media content playing page, where the target media content comprises object information of at least one predetermined object, and the object information includes identification information and/or association information;
Step 702: in response to a triggering operation of a second user on first object information in the at least one object information, switching to a content displaying page, and displaying, in the content displaying page, a resource content associated with the object information.

In this embodiment, after the first user generates the target media based on the uploaded or captured media content to be recognized, the target media content may be posted. Correspondingly, when the second user performs a browsing operation of the media content in the media content playing page, the currently played media content may be switched. When switching to the target media content posted by the first user, the target media content may be played in the media content playing page, the target media content comprises object information of at least one predetermined object, and the object information comprises identification information and/or association information.

The second user may perform a triggering operation on first object information in the at least one object information in the target media content according to an actual requirement. In response to the triggering operation, the content displaying page may be switched to. A resource content associated with the object information is displayed in the content displaying page. Thus, the user can obtain a further understanding of the object information within the content displaying page.

The resource content comprises at least one media content different from the target media content. For example, the resource content may be encyclopedia information associated with the object information, graphic introduction information associated with the object information, item link information associated with the object information, and the like.

FIG. 8 is a schematic diagram of interface interaction according to an embodiment of the present disclosure. As shown in FIG. 8, a media content playing page 81 plays a target media content 82. The target media content 82 comprises object information of at least one predetermined object, for example, the object information may specifically be identification information 83. In response to a triggering operation of the second user on the identification information 83, a content displaying page 84 may be switched to, and a resource content 85 associated with the object information may be displayed in the content displaying page 84.

Further, based on any of the above embodiments, the method further comprises:
displaying, in the content displaying page, a resource content associated with second object information in the at least one object information in response to a switching operation on the content displaying page.

In this embodiment, since there may be a plurality of object information in the target media content, the second user may select a resource content corresponding to different object information for viewing according to the actual requirement.

The second user may trigger the switching operation in the content displaying page to implement the switching operation on the object information. Correspondingly, in response to the switching operation triggered by the second user in the content displaying page, the resource content associated with the second object information in the at least one object information may be displayed in the content displaying page. For example, the switching operation may be a left-right swiping operation, an up-down swiping operation, or an object information click acting on the content displaying page.

According to the media content processing method provided by this embodiment, the target media content including the object information of the at least one predetermined object is played in the media content playing page, and in response to the triggering operation of the user on the first object information, the content displaying page is switched to, and the resource content associated with the object information is displayed in the content displaying page. Thus, the display effect of the target media content can be enriched, and in addition, the user can quickly learn about the first object information.

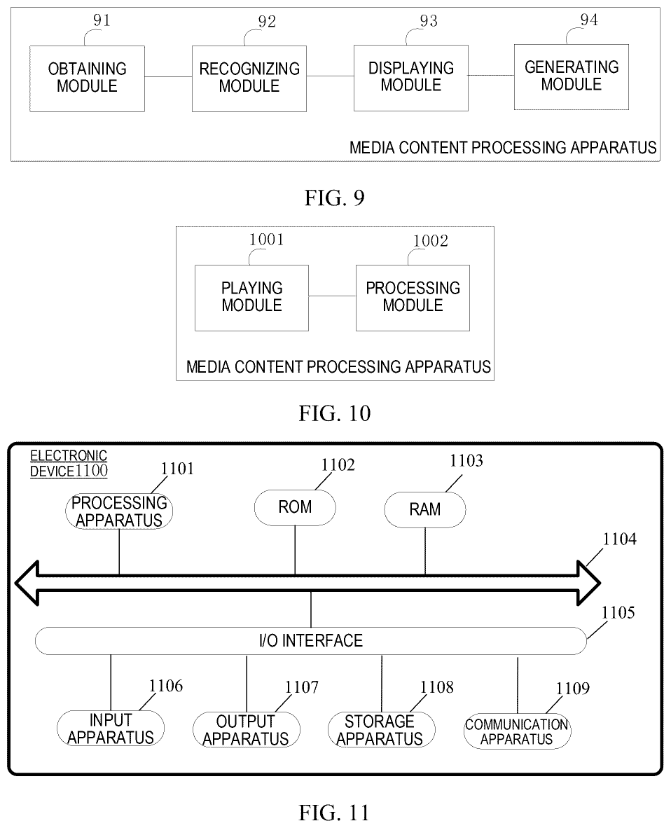

FIG. 9 is a schematic structural diagram of a media content processing apparatus according to an embodiment of the present disclosure. As shown in FIG. 9, the apparatus comprises: an obtaining module 91, a recognizing module 92, a displaying module 93 and a generating module 94. The obtaining module 91 is configured to obtain a media content to be recognized in response to an obtaining operation in a content recognition page. The recognizing module 92 is configured to recognize the media content to be recognized to determine recognition information corresponding to the media content to be recognized. The displaying module 93 is configured to display at least one recognition result corresponding to the recognition information, wherein the recognition result comprises identification information and/or association information of a predetermined object in the media content to be recognized. The generating module 94 is configured to generate, in response to a posting operation triggered by a first user, a target media content obtained based on the obtaining operation, wherein the target media content comprises at least one recognition result.

Further, on the basis of any one of the above embodiments, the media content to be recognized comprises any one of an image media content, a music media content, a video media content, and a text media content.

Further, on the basis of any one of the above embodiments, the obtaining module is configured to: in response to a capturing operation triggered by the first user in the content recognition page, capture the media content to be recognized through a predetermined content capturing component; alternatively, upload the media content to be recognized through a predetermined content uploading component in response to an uploading operation triggered by the first user in the content recognition page.

Further, on the basis of any one of the above embodiments, the generating module is configured to add the identification information and/or the association information of the predetermined object at a position matching each predetermined object in the media content to be recognized to obtain the target media content.

Further, on the basis of any one of the above embodiments, the apparatus further comprises: a first posting module configured to post the target media content.

Further, on the basis of any one of the above embodiments, the apparatus further comprises: a displaying module configured to switch to a recognition result page, display a predetermined posting control, an image content associated with the target media content and/or a resource content associated with the at least one recognition result in the recognition result page.

Further, on the basis of any one of the above embodiments, the displaying module is configured to: switch to the recognition result page in response to determining the recognition information corresponding to the media content to be recognized.

Further, on the basis of any one of the above embodiments, the displaying module is configured to: for any predetermined object in the media content to be recognized, display a recognition result corresponding to the predetermined object in real time at a displaying position matching the predetermined object; in response to a triggering operation of the first user on the recognition result corresponding to any predetermined object, switch to the recognition result page, and display a predetermined posting control, an image content associated with the target media content and/or a resource content associated with the at least one recognition result in the recognition result page.

Further, on the basis of any one of the above embodiments, the apparatus further comprises: a displaying module configured to display a predetermined posting control in the content recognition page. The generating module is configured to generate, in response to a triggering operation of the first user on the posting control, a target media content obtained based on the obtaining operation.

Further, on the basis of any one of the above embodiments, the generating module is configured to generate, in response to a triggering operation of the first user on the posting control, a target media content obtained based on the obtaining operation.

Further, on the basis of any one of the above embodiments, the displaying module is configured to: display an image content associated with the target media content and at least one recognition mark corresponding to the image content associated with the target media content in a first displaying area in the recognition result page; and display a resource content associated with the first recognition mark and a predetermined posting control in a second displaying area in the recognition result page.

Further, on the basis of any one of the above embodiments, after displaying the resource content associated with the first recognition mark and the predetermined posting control in the second displaying area in the recognition result page, the method further comprises: in response to a switching operation of the first user in the recognition result page, switching to display, in the second displaying area, a resource content associated with a second recognition mark.

Further, on the basis of any one of the above embodiments, the generating module is configured to: switch to a predetermined editing page in response to a first predetermined operation triggered by the first user; and generate and post the target media content in response to a second predetermined operation triggered by the first user in the editing page.

FIG. 10 is a schematic structural diagram of a media content processing apparatus according to another embodiment of the present disclosure. As shown in FIG. 10, the apparatus comprises: a playing module 1001, and a processing module 1002. The playing module 1001 is configured to play a target media content in a media content playing page, wherein the target media content comprises object information of at least one predetermined object, and the object information comprises identification information and/or association information. The processing module 1002 is configured to, in response to a triggering operation of a second user on first object information in the at least one object information, switch to a content displaying page, and display, in the content displaying page, a resource content associated with the object information.

Further, on the basis of any one of the above embodiments, the resource content comprises at least one media content different from the target media content.

Further, on the basis of any one of the foregoing embodiments, the apparatus further comprises: a content displaying module configured to display, in the content displaying page, a resource content associated with second object information in the at least one object information in response to a switching operation on the content displaying page.

The device provided in this embodiment may be configured to perform the technical solutions in the foregoing method embodiments, with similar implementation principles and technical effect, which is not repeated in this embodiment.

In order to implement the above embodiments, an embodiment of the present disclosure further provides an electronic device, comprising: a processor and a memory.

The memory stores computer-executable instructions.

The processor executes the computer executable instructions stored in the memory, so that the processor performs the media content processing method according to any one of the above embodiments.

FIG. 11 is a structural schematic diagram of an electronic device provided by an embodiment of the present disclosure. As shown in FIG. 11, the electronic device 1100 may be a terminal device or a server. The terminal device may include, without limitation to, a mobile terminal such as a mobile phone, a notebook computer, a digital broadcast receiver, a PDA (personal digital assistant), a PAD (portable Android device), a PMP (portable multimedia player), an on-board terminal (e.g., an on-board navigation terminal) and the like, and a fixed terminal such as digital TV, a desktop computer and the like. The electronic device shown in FIG. 11 is merely an example and should not be construed as bringing any restriction on the functionality and usage scope of the embodiments of the present disclosure.

As shown in FIG. 11, the electronic device 1100 may comprises a processing apparatus (e.g., a central processor, a graphics processor) 1101 which is capable of performing various appropriate actions and processes in accordance with programs stored in a read only memory (ROM) 1102 or programs loaded from a storage apparatus 1108 to a random access memory (RAM) 1103. In the RAM 1103, there are also stored various programs and data required by the electronic device 1100 when operating. The processing apparatus 1101, the ROM 1102 and the RAM 1103 are connected to one another via a bus 1104. An input/output (I/O) interface 1105 is also connected to the bus 1104.

Usually, the following apparatuses may be connected to the I/O interface 1105: an input apparatus 1106 including a touch screen, a touch pad, a keyboard, a mouse, a camera, a microphone, an accelerometers, a gyroscope, or the like; an output apparatus 1107, such as a liquid-crystal display (LCD), a loudspeaker, a vibrator, or the like; a storage apparatus 1108, such as a magnetic tape, a hard disk or the like; and a communication apparatus 1109. The communication apparatus 1109 allows the electronic device to perform wireless or wired communication with other device so as to exchange data with other device. While FIG. 11 shows the electronic device 1100 with various apparatuses, it should be understood that it is not required to implement or have all of the illustrated apparatuses. Alternatively, more or less apparatuses may be implemented or exist.

Specifically, according to the embodiments of the present disclosure, the procedures described with reference to the flowchart may be implemented as computer software programs. For example, the embodiments of the present disclosure comprise a computer program product that comprises a computer program embodied on a non-transitory computer-readable medium, the computer program including program codes for executing the method shown in the flowchart. In such an embodiment, the computer program may be loaded and installed from a network via the communication apparatus 1109, or installed from the storage apparatus 1108, or installed from the ROM 1102. The computer program, when executed by the processing apparatus 1101, perform the above functions defined in the method of the embodiments of the present disclosure.

It is noteworthy that the computer readable medium of the present disclosure can be a computer readable signal medium, a computer readable storage medium or any combination thereof. The computer readable storage medium may be, for example, but is not limited to, an electronic, magnetic, optical, electromagnetic, infrared or semiconductor system, apparatus or device, or any combination of the foregoing. More specific examples of the computer readable storage medium may include, without limitation to, the following: an electrical connection with one or more conductors, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer readable storage medium may be any tangible medium containing or storing a program which may be used by an instruction executing system, apparatus or device or used in conjunction therewith. In the present disclosure, the computer readable signal medium may include a data signal propagated in baseband or as part of a carrier wave, with computer readable program code carried therein. The data signal propagated as such may take various forms, including without limitation to, an electromagnetic signal, an optical signal or any suitable combination of the foregoing. The computer readable signal medium may further be any other computer readable medium than the computer readable storage medium, which computer readable signal medium may send, propagate or transmit a program used by an instruction executing system, apparatus or device or used in conjunction with the foregoing. The program code included in the computer readable medium may be transmitted using any suitable medium, including without limitation to, an electrical wire, an optical fiber cable, RF (radio frequency), etc., or any suitable combination of the foregoing.

In order to implement the foregoing embodiments, an embodiment of the present disclosure further provides a computer-readable storage medium, wherein the computer-readable storage medium stores computer-executable instructions which, when executed by a processor, implement the media content processing method according to any one of the foregoing embodiments.

In order to implement the foregoing embodiments, an embodiment of the present disclosure further provides a computer program product, comprising a computer program, wherein the computer program, when executed by a processor, implements the media content processing method according to any one of the foregoing embodiments.

The above computer-readable medium may be included in the above-mentioned electronic device; and it may also exist alone without being assembled into the electronic device.

The computer-readable medium carries one or more programs which, when executed by the electronic device, cause the electronic device to perform the method described in the foregoing embodiments.

Computer program codes for carrying out operations of the present disclosure may be written in one or more programming languages, including without limitation to, an object oriented programming language such as Java, Smalltalk, C++ or the like, and conventional procedural programming languages, such as the “C” programming language or similar programming languages. The program codes may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The apparatuses described in the embodiments of the present disclosure may be implemented as software or hardware. Wherein the name of a module does not form any limitation to the module per se. For example, the first obtaining apparatus may further be described as an “apparatus for obtaining at least two Internet Protocol addresses.”The functions described above may be executed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In the context of the present disclosure, the machine readable medium may be a tangible medium, which may include or store a program used by an instruction executing system, apparatus or device or used in conjunction with the foregoing. The machine readable medium may be a machine readable signal medium or a machine readable storage medium. The machine readable medium may include, but is not limited to, an electronic, magnetic, optical, electromagnetic, infrared, semiconductor system, means or device, or any suitable combination of the foregoing. More specific examples of the machine readable storage medium include the following: an electric connection with one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

In a first aspect, according to one or more embodiments of the present disclosure, a media content processing method is provided, comprising:
obtaining a media content to be recognized in response to an obtaining operation in a content recognition page;
recognizing the media content to be recognized to determine recognition information corresponding to the media content to be recognized;
displaying at least one recognition result corresponding to the recognition information, wherein the recognition result comprises identification information and/or association information of a predetermined object in the media content to be recognized; and
generating, in response to a posting operation triggered by a first user, a target media content obtained based on the obtaining operation, wherein the target media content comprises the at least one recognition result.

According to one or more embodiments of the present disclosure, the obtaining a media content to be recognized in response to an obtaining operation in a content recognition page comprises:
in response to a capturing operation triggered by the first user in the content recognition page, capturing the media content to be recognized through a predetermined content capturing component; or
uploading the media content to be recognized through a predetermined content uploading component in response to an uploading operation triggered by the first user in the content recognition page.

According to one or more embodiments of the present disclosure, the media content to be recognized comprises any one of an image media content, a music media content, a video media content, and a text media content.

According to one or more embodiments of the present disclosure, after the recognizing the media content to be recognized to determine recognition information corresponding to the media content to be recognized, the method further comprises:
switching to a recognition result page, and displaying a predetermined posting control, an image content associated with the target media content and/or a resource content associated with the at least one recognition result in the recognition result page.

According to one or more embodiments of the present disclosure, the switching to a recognition result page comprises:
switching to the recognition result page in response to determining the recognition information corresponding to the media content to be recognized.

According to one or more embodiments of the present disclosure, the displaying at least one recognition result corresponding to the recognition information comprises:
for any predetermined object in the media content to be recognized, displaying a recognition result corresponding to the predetermined object in real time at a displaying position matching the predetermined object; and
in response to a triggering operation of the first user on the recognition result corresponding to any predetermined object, switching to the recognition result page, and displaying a predetermined posting control, an image content associated with the target media content and/or a resource content associated with the at least one recognition result in the recognition result page.

According to one or more embodiments of the present disclosure, after the recognizing the media content to be recognized to determine recognition information corresponding to the media content to be recognized, the method further comprises:
displaying a predetermined posting control in the content recognition page;
the generating a target media content obtained based on the obtaining operation in response to a posting operation triggered by a first user comprises:
generating a target media content obtained based on the obtaining operation in response to a triggering operation of the first user on the posting control.

According to one or more embodiments of the present disclosure, the generating a target media content obtained based on the obtaining operation in response to a posting operation triggered by a first user comprises:
generating a target media content obtained based on the obtaining operation in response to a triggering operation of the first user on the posting control.

According to one or more embodiments of the present disclosure, the displaying a predetermined posting control, an image content associated with the target media content and/or a resource content associated with the at least one recognition result in the recognition result page comprises:
displaying an image content associated with the target media content and at least one recognition mark corresponding to the image content associated with the target media content in a first displaying area in the recognition result page; and
displaying a resource content associated with the first recognition mark and a predetermined posting control in a second displaying area in the recognition result page.

According to one or more embodiments of the present disclosure, after the displaying a resource content associated with the first recognition mark and a predetermined posting control in a second displaying area in the recognition result page, the method further comprises:
in response to a switching operation of the first user in the recognition result page, switching to display, in the second displaying area, a resource content associated with a second recognition mark.

According to one or more embodiments of the present disclosure, the generating a target media content obtained based on the obtaining operation comprises:
adding the identification information and/or the association information of the predetermined object at a position matching each predetermined object in the media content to be recognized to obtain the target media content.

According to one or more embodiments of the present disclosure, after the generating a target media content obtained based on the obtaining operation, the method further comprises:
posting the target media content.

According to one or more embodiments of the present disclosure, the generating a target media content obtained based on a posting operation triggered by the first user comprises:
switching to a predetermined editing page in response to a first predetermined operation triggered by the first user; and
generating and posting the target media content in response to a second predetermined operation triggered by the first user in the editing page.

Thus, the application scenarios of the content recognition function are enriched, the user can post the target media content based on the recognition result of the content recognition function, the content recognition function is made to better fit actual needs of the user, and the user experience is improved.

In a second aspect, according to one or more embodiments of the present disclosure, a media content processing method is provided, further comprising:
playing a target media content in a media content playing page, wherein the target media content comprises object information of at least one predetermined object, and the object information comprises identification information and/or association information; and
in response to a triggering operation of a second user on first object information in the at least one object information, switching to a content displaying page, and displaying, in the content displaying page, a resource content associated with the object information.

According to one or more embodiments of the present disclosure, the resource content comprises at least one media content different from the target media content.

According to one or more embodiments of the present disclosure, the method further comprises:
displaying, in the content displaying page, a resource content associated with second object information in the at least one object information in response to a switching operation on the content displaying page.

In a third aspect, according to one or more embodiments of the present disclosure, a media content processing apparatus is provided, comprising:
an obtaining module configured to obtain a media content to be recognized in response to an obtaining operation in a content recognition page;
a recognizing module configured to recognize the media content to be recognized to determine recognition information corresponding to the media content to be recognized;
a displaying module configured to display at least one recognition result corresponding to the recognition information, wherein the recognition result comprises identification information and/or association information of a predetermined object in the media content to be recognized; and
a generating module configured to generate, in response to a posting operation triggered by a first user, a target media content obtained based on the obtaining operation, wherein the target media content comprises the at least one recognition result.

According to one or more embodiments of the present disclosure, the obtaining module is configured to:
in response to a capturing operation triggered by the first user in the content recognition page, capture the media content to be recognized through a predetermined content capturing component; or
upload the media content to be recognized through a predetermined content uploading component in response to an uploading operation triggered by the first user in the content recognition page.

According to one or more embodiments of the present disclosure, the media content to be recognized comprises any one of an image media content, a music media content, a video media content, and a text media content.

According to one or more embodiments of the present disclosure, the apparatus further comprises:
a displaying module further configured to switch to a recognition result page, and display a predetermined posting control, an image content associated with the target media content and/or a resource content associated with the at least one recognition result in the recognition result page.

According to one or more embodiments of the present disclosure, the displaying module is configured to:
switch to the recognition result page in response to determining the recognition information corresponding to the media content to be recognized.

According to one or more embodiments of the present disclosure, the displaying module is configured to:
for any predetermined object in the media content to be recognized, display a recognition result corresponding to the predetermined object in real time at a displaying position matching the predetermined object; and
in response to a triggering operation of the first user on the recognition result corresponding to any predetermined object, switch to the recognition result page, and display a predetermined posting control, an image content associated with the target media content and/or a resource content associated with the at least one recognition result in the recognition result page.

According to one or more embodiments of the present disclosure, the apparatus further comprises:
a displaying module further configured to display a predetermined posting control in the content recognition page;
the generating module is configured to:
generate a target media content obtained based on the obtaining operation in response to a triggering operation of the first user on the posting control.

According to one or more embodiments of the present disclosure, the generating module is configured to:
generate a target media content obtained based on the obtaining operation in response to a triggering operation of the first user on the posting control.

According to one or more embodiments of the present disclosure, the displaying module is configured to:
display an image content associated with the target media content and at least one recognition mark corresponding to the image content associated with the target media content in a first displaying area in the recognition result page; and
display a resource content associated with the first recognition mark and a predetermined posting control in a second displaying area in the recognition result page.

According to one or more embodiments of the present disclosure, after the displaying a resource content associated with the first recognition mark and a predetermined posting control in a second displaying area in the recognition result page, the apparatus further comprises:
in response to a switching operation of the first user in the recognition result page, switching to display, in the second displaying area, a resource content associated with a second recognition mark.

According to one or more embodiments of the present disclosure, the generating module is configured to:
add the identification information and/or the association information of the predetermined object at a position matching each predetermined object in the media content to be recognized to obtain the target media content.

According to one or more embodiments of the present disclosure, the apparatus further comprises:

a first posting module configured to post the target media content.

According to one or more embodiments of the present disclosure, the generating module is configured to:
switch to a predetermined editing page in response to a first predetermined operation triggered by the first user; and
generate and post the target media content in response to a second predetermined operation triggered by the first user in the editing page.

In a fourth aspect, according to one or more embodiments of the present disclosure, a media content processing apparatus is provided, comprising:
a playing module configured to play a target media content in a media content playing page, wherein the target media content comprises object information of at least one predetermined object, and the object information comprises identification information and/or association information; and
a processing module configured to, in response to a triggering operation of a second user on first object information in the at least one object information, switch to a content displaying page, and display, in the content displaying page, a resource content associated with the object information.

According to one or more embodiments of the present disclosure, the resource content comprises at least one media content different from the target media content.

According to one or more embodiments of the present disclosure, the apparatus further comprises:

a content displaying module configured to display, in the content displaying page, a resource content associated with second object information in the at least one object information in response to a switching operation on the content displaying page.

In a fifth aspect, according to one or more embodiments of the present disclosure, an electronic device is provided, comprising: at least one processor and a memory; wherein
the memory stores computer executable instructions;
the at least one processor executes the computer-executable instructions stored in the memory, so that the at least one processor executes the media content processing method according to the first aspect and various possible designs of the first aspect.

In a sixth aspect, according to one or more embodiments of the present disclosure, a computer-readable storage medium is provided, wherein the computer-readable storage medium stores computer-executable instructions which, when executed by a processor, implement the media content processing method according to the first aspect and various possible designs of the first aspect.

In a seventh aspect, according to one or more embodiments of the present disclosure, a computer program product is provided, comprising a computer program, wherein the computer program, when executed by a processor, implements the media content processing method according to the first aspect and various possible designs of the first aspect.

In an eighth aspect, according to one or more embodiments of the present disclosure, a computer program is provided, wherein the computer program, when executed by a processor, implements the media content processing method according to the first aspect and various possible designs of the first aspect. The foregoing description merely illustrates the preferable embodiments of the present disclosure and used technical principles. Those skilled in the art should understand that the scope of the present disclosure is not limited to technical solutions formed by specific combinations of the foregoing technical features and also cover other technical solution formed by any combinations of the foregoing or equivalent features without departing from the concept of the present disclosure, such as a technical solution formed by replacing the foregoing features with the technical features disclosed in the present disclosure (but not limited to) with similar functions.

In addition, although various operations are depicted in a particular order, this should not be construed as requiring that these operations be performed in the particular order shown or in a sequential order. In a given environment, multitasking and parallel processing may be advantageous. Likewise, although the above discussion contains several specific implementation details, these should not be construed as limitations on the scope of the present disclosure. Certain features that are described in the context of separate embodiments can also be implemented in combination in a single embodiment. Conversely, various features that are described in the context of a single embodiment can also be implemented in multiple embodiments separately or in any suitable sub-combination.

Although the subject matter has been described in language specific to structural features and/or method logical acts, it is to be understood that the subject matter defined in the appended claims is not necessarily limited to the specific features or acts described above. On the contrary, the specific features and acts described above are merely example forms of implementing the claims.

1. A media content processing method, comprising:
obtaining a media content in response to an obtaining operation
recognizing the media content to determine recognition information corresponding to the media content;
displaying at least one recognition result corresponding to the recognition information, the recognition result comprising at least one of identification information or association information of a predetermined object in the media content; and
generating, in response to a posting operation, a target media content obtained based on the obtaining operation, the target media content comprising the at least one recognition result.

2. The method of claim 1, wherein obtaining the media content in response to the obtaining operation in the content recognition page comprises:
capturing the media content through a predetermined content capturing component in response to a capturing operation; or
uploading the media content through a predetermined content uploading component in response to an uploading operation.

3. The method of claim 1, wherein the media content comprises any one of an image media content, a music media content, a video media content, or a text media content.

4. The method of claim 1, wherein after recognizing the media content to determine the recognition information corresponding to the media content, the method further comprises:
switching to a recognition result page, and displaying, a predetermined posting control, and at least one of an image content associated with the target media content or a resource content associated with the at least one recognition result.

5. The method of claim 4, wherein switching to the recognition result page comprises:
switching to a recognition result page in response to determining the recognition information corresponding to the media content.

6. The method of claim 1, any wherein displaying the at least one recognition result corresponding to the recognition information comprises:
displaying, for any predetermined object in the media content, a recognition result corresponding to the predetermined object in real time at a displaying position matching the predetermined object; and
in response to a triggering operation on the recognition result corresponding to any predetermined object, switching to the recognition result page, and displaying, in the recognition result page, a predetermined posting control, and at least one of an image content associated with the target media content or a resource content associated with the at least one recognition result.

7. The method of claim 1, any wherein after recognizing the media content to determine the recognition information corresponding to the media content, the method further comprises: displaying a predetermined posting control in the content recognition page; and
generating the target media content obtained based on the obtaining operation in response to the posting operation comprises: generating the target media content obtained based on the obtaining operation in response to a triggering operation on the posting control.

8. The method of claim 4, wherein generating the target media content obtained based on the obtaining operation in response to the posting operation comprises:
generating the target media content obtained based on the obtaining operation in response to a triggering operation on the posting control.

9. The method of claim 4, wherein displaying in the recognition result page the predetermined posting control, and the at least one of the image content associated with the target media content or the resource content associated with the at least one recognition result comprises:
displaying the image content associated with the target media content and at least one recognition mark corresponding to the image content associated with the target media content in a first displaying area in the recognition result page; and
displaying a resource content associated with the first recognition mark and the predetermined posting control in a second displaying area in the recognition result page.

10. The method of claim 9, wherein after displaying the resource content associated with the first recognition mark and the predetermined posting control in the second displaying area in the recognition result page, the method further comprises:
in response to a switching operation in the recognition result page, switching to displaying, in the second displaying area, a resource content associated with a second recognition mark.

11. The method of claim 1, wherein generating the target media content obtained based on the obtaining operation comprises:
adding, at a position matching each predetermined object in the media content, at least one of the identification information and/or the association information of the predetermined object, to obtain the target media content.

12. The method of claim 1, any wherein after generating the target media content obtained based on the obtaining operation, the method further comprises:
posting the target media content.

13. The method of claim 1, wherein generating the target media content obtained based on the posting operation in response to the posting operation comprises:
switching to a predetermined editing page in response to a first predetermined operation; and
generating and posting the target media content in response to a second predetermined operation in the editing page.

14. A media content processing method, comprising:
playing a target media content, the target media content comprising object information of at least one predetermined object, and the object information comprising at least one of identification information or association information; and
in response to a triggering operation on first object information in the at least one object information, switching to a content displaying page, and displaying, in the content displaying page, a resource content associated with the object information.

15. The method of claim 14, wherein the resource content comprises at least one media content different from the target media content.

16. The method of claim 14, further comprising:
displaying, in the content displaying page, a resource content associated with second object information in the at least one object information in response to a switching operation in the content displaying page.

17. (canceled)

18. (canceled)

19. (canceled)

20. (canceled)

21. (canceled)

22. (canceled)

23. An electronic device, comprising: a processor and a memory,
the memory storing computer executable instructions;
the at least one processor executing the computer-executable instructions stored in the memory, to cause the at least one processor to perform acts for media content processing, the acts comprising:
obtaining a media content in response to an obtaining operation in a content recognition page;
recognizing the media content to determine recognition information corresponding to the media content;
displaying at least one recognition result corresponding to the recognition information, the recognition result comprising at least one of identification information or association information of a predetermined object in the media content; and
generating, in response to a posting operation triggered by a first user, a target media content obtained based on the obtaining operation, the target media content comprising the at least one recognition result.

24. The electronic device of claim 23, wherein obtaining the media content in response to the obtaining operation in the content recognition page comprises:
capturing the media content through a predetermined content capturing component in response to a capturing operation in the content recognition page; or
uploading the media content through a predetermined content uploading component in response to an uploading operation in the content recognition page.

25. The electronic device of claim 23, wherein the media content comprises any one of an image media content, a music media content, a video media content, or a text media content.

26. The electronic device of claim 23, wherein after recognizing the media content to determine the recognition information corresponding to the media content, the acts further comprises:
switching to a recognition result page, and displaying, in the recognition result page, a predetermined posting control, and at least one of an image content associated with the target media content or a resource content associated with the at least one recognition result.
